(19) United States
(12) Patent Application Publication
(10) Pub. No.: US 2008/0263915 A1
(43) Pub. Date: Oct. 30, 2008

(54) Locker decoration

(76) Inventor: Cale Jenks Wardell, Lake Forest, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/148,961

(22) Filed: Apr. 24, 2008

Related U.S. Application Data
(60) Provisional application No. 60/913,918, filed on Apr. 25, 2007.

(51) Int. Cl. G09F 11/00

(52) U.S. Cl. 40/1

(57) ABSTRACT

A decorative locker covering for decorating the surface or door of a school locker includes a durable backing sheet having a front side and a back side, a cover sheet having a front side and a back side wherein the back side of the cover sheet is affixed to the front side of the backing sheet, or wherein the back side of the cover sheet is the backing sheet. The decorative locker covering can comprise the magnetic backing sheet and/or may comprise a plurality of releasable fasteners affixed to the back side of the backing sheet. Additionally, the decorative covering can include a plurality of decorative elements attached to the front side of the cover sheet, at least one envelope additionally attached to the front side of the cover sheet, and at least one writing implement attached to the front side of the cover sheet.

### FIELD OF THE INVENTION

The present invention relates to decorative coverings for the inner or outer surfaces of one or more standard size school lockers (“locker”), such as is typically found in elementary schools, junior high schools, and high schools.

### BACKGROUND OF THE INVENTION

Decorating locker doors in school hallways is a very popular activity for many young adolescents, especially girls. A girl's locker is often decorated by a friend or friends in order to surprise the recipient of the decoration and to express their feelings of friendship. Typically such locker decoration is done for various special occasions like a girl's birthday, or to wish a teammate or player well in a school sporting event. In doing so, often times the outside front surface of a locker door is covered with gift wrapping paper that contains celebratory messages, such as “Happy Birthday,” which is held in place by taping the wrapping paper directly to the locker surface with adhesive backed tape. Additionally and alternatively, the recipient of the locker decorations can often times find items such as adhesive backed ribbons meant for gifts, greeting cards with celebratory messages written inside, pens or markers for writing inside the greeting cards or on the wrapping paper itself, and other novelty items like candy or pictures fastened to the outer surface of her locker door by tape or other adhesives.

A problem with these decorations is that often times they damage the outer front surface of the locker door to which they are fastened, especially when the decorations are removed. First, the tape that is used to attach many of the decorations to the lockers is often left in place and the paper is simply torn off the locker when it comes time to remove the decorations. Second, the majority of school locker doors are made of sheet metal, for security reasons, and are painted bright colors rather than simply being bare, sheet metal gray colored. Upon removal of the tape that is used to attach the decorations to the lockers, the adhesive may be too strong and pull the paint off of the locker leaving the locker permanently marked or damaged. Third, if the tape is left in place too long or the adhesive is too strong, when removing the tape, the adhesive may delaminate from the tape substrate it was originally attached to and remain on the locker surface after the tape has been peeled off the locker. Fourth, if permanent markers are used to write various messages on the wrapping paper covering the locker door, often the ink from the marker may soak through the wrapping paper and permanently mark the surface of the locker door. All of this either permanently damages the locker door beneath the decorations or requires significant cleaning or painting efforts to repair or remove the markings.

Another problem associated with these decorations as they have been applied to lockers thus far is that, when it comes time to remove the decorations from the locker, they are most often times simply torn off the front of the locker and discarded rather than being saved as a keepsake or memento, because wrapping paper on its own is not a very durable paper. Rather, wrapping paper is designed to be easily torn to facilitate the ease of opening the gifts wrapped therein. Accordingly, when the wrapping paper used to decorate a locker door is removed, it often ends up in pieces on the ground for janitorial services to clean up, which is a problem in many schools.

### SUMMARY OF THE INVENTION

According to the present invention herein disclosed, a decorative locker covering in the shape and size of a school locker includes a printed decorative cover sheet, similar to wrapping paper, affixed to the front side of a flexible but durable backing sheet. In one embodiment, the cover sheet and the backing sheet are one unit so that the backing sheet is simply the back side of the cover sheet. In a preferred embodiment the backing sheet is made of a magnetic material. The printing on the front side of the cover sheet can be virtually anything, an example of which would be printing for a birthday theme containing celebratory messages such as “Happy Birthday” and images such as graphics of birthday cakes. In one embodiment, the cover sheet may be a whiteboard, or other similar surface, on which one can write various messages. In another embodiment, the cover sheet may comprise a mirror. In another embodiment, the cover sheet may comprise a photo frame. In yet another embodiment, the cover sheet may serve as a locker wallpaper. The backing sheet may further include a plurality of integral fasteners attached thereto to facilitate the temporary mounting of the decorative locker covering on the outer front or inner surface or door of a school locker, preferably a standard metal school locker. The fasteners are any such fastener that will allow for temporary mounting of the locker covering and easy removal thereof, while at the same time neither damaging the surface of the locker to which it is attached or the decorative covering itself upon removal from the locker. While other door decorations may exist in the art, they do not generally come with integral fastening means and as such often need to be applied to a door via an adhesive tape such as cellophane tape. Accordingly, if the adhesive is too strong, upon removing the tape from the door surface or the decoration to which the tape is attached, damage may be caused to both the surface of the door and the decoration. One benefit of the present invention is that the integral fasteners or the magnetic backing sheet-allow the user to apply the decorative locker covering to the surface of the locker and remove it without causing damage to either the locker or the decorative covering. In this manner the decorative covering is savable and may be kept as a memento at home or reused by the recipient to decorate an inner surface of the recipient's locker, or for future reuse and no repairs need to be made to the surface to which it was attached upon its removal. Additionally, because the decorative locker covering is meant to be retainable and savable, unlike a locker door having plain wrapping paper taped to it as a decoration, it is much less likely that when it comes time to remove the covering that it would be simply torn off a locker and end up in pieces left on the ground for janitorial services to clean up.

Furthermore, the decorative locker covering may include a plurality of decorative elements affixed to the printed front side of the cover sheet in order to further accentuate and complement the printing on the cover sheet. For example the decorative elements of bows and ribbons help to complement and further communicate a “Happy Birthday” celebratory message printed on the cover sheet. Additionally, at least one envelope may be affixed to the cover sheet to hold greeting cards, notes, or letters left by friends and those passing by the decorative locker covering. In one embodiment, the cover sheet may be a whiteboard, or other similar surface on which one can write or draw. The decorative locker covering may also have permanently affixed thereto at least one writing implement so individuals passing by may, at that moment, leave further messages or writings on the locker covering itself, or use the writing implement to write separate, notes, cards, or letters and thus leave them in the envelope as previously mentioned.

### BRIEF DESCRIPTION OF THE DRAWINGS

FIG. 1 is an exploded, front side isometric view of one embodiment of decorative locker covering made in accordance with the present invention.

### DETAILED DESCRIPTION OF THE INVENTION

A skilled artisan would recognize that the presently preferred embodiments are considered to be examples of the invention, and are not intended to limit the invention to the specific embodiments illustrated.

Preferably, the present invention is a durable, single piece, removable, and savable decorative locker covering for decorating the surface or door of a locker.

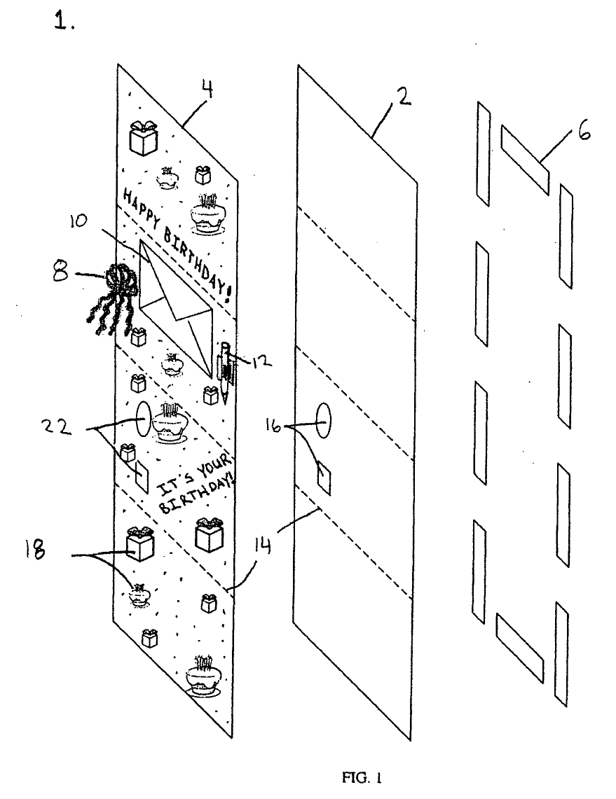

Referring to FIG. 1, a decorative locker covering 1 is disclosed. Locker Covering 1 includes a durable backing sheet 2, a decorative printed cover sheet 4, a plurality of fasteners 6, a plurality of decorative elements 8, at least one envelope 10, and at least one writing implement 12.

In the preferred embodiment, the durable backing sheet 2 has a front side and a back side. Backing sheet 2 is generally constructed from a thin flexible, durable, material such as cardboard, in the shape and size of the front surface of a school locker door, however, the disclosure of this embodiment should not be read to limit the shape or size of the backing sheet 2 or the overall decorative locker covering 1. Alternatively, the durable backing sheet 2 may be composed of other durable materials like a thin flexible foam board or flexible plastic sheet board. In another embodiment, backing sheet 2 is constructed of a magnetic material. Preferably backing sheet 2 has creases or perforations 14 across the width of the backing sheet at various locations on its surface such that decorative locker covering 1 can be saved and neatly folded for storage. Backing sheet 2 may additionally include at least one cutout 16 in a shape and size sufficient to allow a school locker combination lock, preferably a standard school combination lock, whether built into the locker door or as a separate padlock, and a school locker door release latch, to protrude there through. Alternatively, the cutouts 16 can be a plurality of perforated knockouts to allow the user to choose which knockout locations to remove such that the lock and release latch are allowed to protrude there through.

Cover sheet 4 is generally a single sheet having a front side and a back side, constructed of a decorative paper similar to wrapping paper used to wrap gifts and packages. Alternatively it may be constructed of heavier weight paper, plastic sheet, or any similar film or sheet material suitable for wrapping and covering said backing sheet 2. Cover sheet 4 preferably has decorative printing 18 on at least its front side. The decorative printing 18 can be virtually any pattern and include printed objects such as pictures, illustrations, graphics, shapes, or text. One such example of the decorative printing would be for use as a birthday theme, in which the cover sheet 4 had printed on the front side thereof the words “Happy Birthday” as well as images of birthday cakes and graphics of gift wrapped packages. In one embodiment, the cover sheet may be a whiteboard, or other similar surface, on which one can write various messages. In another embodiment, the cover sheet may comprise a mirror. In another embodiment, the cover sheet may comprise a photo frame. In yet another embodiment, the cover sheet may serve as a locker wallpaper. In one embodiment, cover sheet 4 additionally includes on the back side thereof a permanent adhesive. The back side of cover sheet 4 may be permanently attached via the adhesive to at least the front side of the backing sheet 2, such that at least the full front side of the backing sheet 2 is completely covered by the cover sheet 4. In another embodiment, the back side of cover sheet 4 is the backing sheet 2. In a preferred embodiment, the backing sheet 2 is made of a magnetic material. Similar to backing sheet 2, cover sheet 4 may additionally include at least one cutout 22 in a shape and size sufficient to allow a school locker combination lock, preferably a standard school combination lock, and a school locker door release latch, to protrude there through. As with the backing sheet 2, the cutouts can alternatively be perforated knockouts. Also, similar to backing sheet 2, cover sheet 4 may additionally include creases or perforations 14 across the width of the cover sheet at various locations on its surface such that decorative locker covering 1 can be saved and neatly folded for storage. When cover sheet 4 and backing sheet 2 are permanently mated, the cutouts or knockouts of each and the creases or perforations of each are preferably in alignment with one another. Alternatively, as opposed to having a separate backing sheet 2 and a separate cover sheet 4 that are mated together, the invention can include a single durable, flexible sheet board with decorative printing one at least one side thereof, preferably containing similar cutouts or knockouts and similar creases or perforations as previously disclosed.

Preferably, the plurality of fasteners 6 are adhesive backed flexible magnets. The magnetic fasteners 6 are affixed to the back side of backing sheet 2 via the adhesive located on the back side of the magnetic fasteners 6. The plurality of fasteners are affixed to the back side of backing sheet 2 in sufficient size, numbers, and locations so as to support the decorative locker covering 1 when it is magnetically attached, in a vertical position, to the front surface of a metal locker door or to a surface inside the locker. As an alternative to using magnetic fasteners to attach the locker covering 1 to a metal locker or if the locker is made of a non-metallic metal or material, the fasteners 6 may instead be releasable, low-tack adhesive strips. The strips would be permanently bonded to backing sheet 2 and have on the opposite surface thereof, a low-tack adhesive similar to that used in Post-it” Notes. The low tack adhesive would be protected by strips of wax paper such that when ready, the user would remove the wax paper from the strip exposing the low tack adhesive beneath it and attach the decorative locker covering 1 to the front face or door or inside wall of a locker in a vertical position. Additional alternatives to magnetic fasteners 6 or low-tack adhesive strips would be to use hooks, latches, elastic bands that slide over the locker door, or any other suitable fasteners to hang a lightweight decorative covering in a vertical position. In any embodiment disclosed above, the decorative locker covering 1 would be removable such that the surface of the locker to which it is attached is neither marked nor damaged. Furthermore, such attachment methods allow the recipient to remove and retain the decorative locker covering 1 so as to be able to save such covering as a memento and retain the decorative locker covering on a surface inside the locker. In one embodiment of the invention, the backing sheet is made of magnetic material, and fasteners are not necessary.

A plurality of decorative elements 8 are permanently attached to the front, printed side of the cover sheet 4. The decorative elements 8 can include virtually anything but shall preferably include at least one bow, and at least one ribbon. However, the disclosure of this embodiment should not be read to limit the number or type of decorative elements that may be attached to the cover sheet or the various combinations with which they can be applied to the front printed side of the cover sheet 4.

Additionally, the decorative locker covering 1 may preferably include at least one envelope 10, which is permanently affixed to the printed front side of cover sheet 4, for holding at least one item which may include a greeting card, note, letter, or message. Additionally, virtually anything may be placed in the envelope 10, such as a small, lightweight gift, and the disclosure of this embodiment should not be read to limit the number or type of item which may be placed therein. Furthermore, envelope 10 may alternatively be any similar type of pouch, pocket, bag, or other similar light weight container for holding various items associated with the theme printed on the cover sheet 4 of the decorative locker covering 1. As another alternative to an external envelope 10, cover sheet 4 and backing sheet 2 could each include an additional slot shaped cutout. An integral pocket, pouch, or envelope would then be affixed to the back side of backing sheet 2, such that the opening of the pocket or envelope completely surrounds the perimeter of the slot cutout located in both the cover sheet 4 and the backing sheet 2. In this manner, items such as cards, notes, and letters may alternately be placed and stored in an integral envelope primarily located between the locker and the decorative locker covering 1, rather than having such items contained in a separately attached envelope 10 affixed to the front side of the cover sheet 4.

Additionally, the decorative locker covering 1 may include a whiteboard or any other surface on which one can write or draw; a mirror; a photo frame, or any other decorative element.

Additionally, the decorative locker covering 1 may preferably include at least one writing instrument. The writing instrument can be of any type or variety including but not limited to, pens, pencils, or markers. The writing instrument is preferably attached to cover sheet 4 via a permanent adhesive backed slip or other fastener for holding said instrument. In this manner, writing instrument may be unclipped or unfastened and separated from the decorative locker covering 1 so as to facilitate writing messages on the decorative locker covering 1 itself, on the whiteboard, on the various greeting cards contained in the envelope 10 as discussed above, or on separate notes or cards that are to be left in envelope 10. Alternatively, the writing instrument may also be attached to the cover sheet 4 of the decorative locker covering 1 by means of a long tether or leash attached at one end to the cover sheet 4, and at the other end to the writing instrument. In this manner, the writing instrument may not be completely separated from the decorative locker covering 1, ensuring the writing instrument will be available for use by anyone who wishes to write a message to the recipient of the decorative locker covering 1. In yet another embodiment, the writing instrument may be kept in a pouch meant for such an instrument, the envelope disclosed above 10, or left to hang by the tether as discussed above.

What is claimed is:

1. A decorative locker covering comprising:
a durable backing sheet;
a cover sheet having a front side and a back side, wherein said back side of said cover sheet is affixed to the backing sheet or wherein said back side of said cover sheet is the said durable backing sheet; and
wherein said durable backing sheet comprises a magnetic surface or a plurality of releasable fasteners fixedly attached to said back side of said backing sheet.

2. The decorative locker covering of claim 1, wherein said locker covering is the shape and size of a school locker door.

3. The decorative locker covering of claim 1, wherein said cover sheet has printing on said front side thereof.

4. The decorative locker covering of claim 1, wherein said cover sheet comprises a mirror.

5. The decorative locker covering of claim 1, wherein said cover sheet comprises a whiteboard.

6. The decorative locker covering of claim 1, wherein said cover sheet comprises a photo frame.

7. The decorative locker covering of claim 1, wherein said decorative locker covering comprises a wallpaper.

8. The decorative locker covering of claim 1, wherein said backing sheet and said cover sheet each include at least one mutually aligned knockout through which a standard combination lock and release latch from said locker may be allowed to protrude.

9. The decorative locker covering of claim 1, wherein said backing sheet and said cover sheet further each include at least one mutually aligned crease across their respective widths through which said locker covering may be folded for storage.

10. The decorative locker covering of claim 8, wherein said locker covering further comprises at least one decorative element fixedly attached to said front side of said cover sheet.

11. The decorative locker covering of claim 10, wherein said decorative element is a bow.

12. The decorative locker covering of claim 1, wherein said locker covering further comprises at least one envelope affixed to said front side of said cover sheet, in a size and orientation such that at least one greeting card may be placed therein.

13. The decorative locker covering of claim 1, wherein said locker covering further comprises at least one writing implement fixedly attached to said front side of said cover sheet.

14. The decorative locker covering of claim 1, wherein said fasteners are flexible, adhesive backed strip magnets.

15. The decorative locker covering of claim 1, wherein said fasteners are low-tack adhesive strips.
